(19) United States
(12) Patent Application Publication
(10) Pub. No.: US 2024/0286231 A1
(43) Pub. Date: Aug. 29, 2024

(54) CONTINUOUSLY COOLED WELD HEAD

(71) Applicant: Critical Systems, Inc., Boise, ID (US)

(72) Inventors: Theodore John Jones, Draper, UT (US); Michael Scott Guerrina, Austin, TX (US); Timothy Andrew Tycz, Boise, ID (US); Joshua G. Belke, Meridian, ID (US); Derek D. Wicklund, Meridian, ID (US)

(21) Appl. No.: 18/585,848

(22) Filed: Feb. 23, 2024

Related U.S. Application Data
(60) Provisional application No. 63/486,863, filed on Feb. 24, 2023.

(51) Int. Cl. B23K 37/00; B23K 9/028

(52) U.S. Cl. CPC B23K 37/003; B23K 9/0286

(57) ABSTRACT

The present disclosure describes a system including a support structure configured to provide support for various orbital welding components. The system also includes an orbital weld head body attached to the support structure. The orbital weld head body is made of a thermally conductive material and includes at least one cooling bar that spans at least a portion of the length of the orbital weld head body. The cooling bar includes various internal cooling channels to route coolant through the cooling bar of the orbital weld head body. The orbital weld head body also includes at least one pressurized fluid input line that attaches to the internal cooling channels of the cooling bar and conducts a fluid coolant to the internal cooling channels of the cooling bar. Other apparatuses and orbital welding machines are also described.

### CROSS-REFERENCE TO RELATED APPLICATIONS

This application claims priority to and the benefit of U.S. Provisional Application No. 63/486,863, filed on Feb. 24, 2023, which application is incorporated by reference herein in its entirety.

### BACKGROUND

Orbital welding is a fusion-based process that uses gas tungsten arc welding (GTAW) technology in a unique way when joining pipe or tubular materials of construction. GTAW is often seen as the cleanest and most often utilized process for high integrity, high performance welding. Orbital welding implements a controller, an inverter power supply, servo motors, and gears, along with sequential programming, to allow the weld head (typically tungsten) to rotate around the workpiece with great consistency. Orbital welding is a homogeneous process that allows the pinpointing of an electric arc, capable of melting small amounts of material at very high temperatures, to accurately fuse together targeted areas of a workpiece, allowing molten material to be targeted and bonded, precisely forming a uniform and mechanically sound weld.

Notably, the GTAW orbital welding process does not require filler material or fluxes. Rather, it bonds the base metal of a fitting or tubular product together, under an inert gas environment or “shield.” Homogeneously fusing the base metal of the weld joint, unlike other processes that use filler metals and fluxes, typically results in a high-integrity weld due to its inherent cleanliness, as no filler metal or flux is required, and the inert gas acts as a shield for the molten metal, greatly reducing possible atmospheric contamination and undesirable molecular characteristics.

Still further, orbital welding requires no “open flame” and is low in contaminants. The orbital welding process provides a superior weld joint, eliminating potential hazards that are often seen in open flame processes that can produce fire and damage to surrounding structures and personnel as well as weld spatter, arc flash, and hazardous smoke. Orbital welding is a “closed arc” process whereby the weld head used to perform the work is enclosed around the workpiece, allowing the inert gas to completely surround the weld area. This protects the weld zone from oxidation and contamination while also protecting the operator from the hazardous arc flash and intense heat produced during the process.

### BRIEF DESCRIPTION OF DRAWINGS

The accompanying drawings illustrate a number of exemplary embodiments and are a part of the specification. Together with the following description, these drawings demonstrate and explain various principles of the present disclosure.

FIGS. 1A and 1B illustrate perspective and side views of an embodiment of an orbital welding system or machine.

FIG. 2 illustrates a perspective, expanded view of an embodiment of an orbital welding removable cassette.

FIG. 3 illustrates a perspective, expanded view of an embodiment of an orbital weld head body.

FIG. 4 illustrates a perspective, expanded view of an embodiment of an orbital weld head.

FIG. 5 illustrates a top view of an embodiment of an orbital welding system or machine, including weld head body and weld head.

FIGS. 6A-6C illustrate embodiments of an orbital weld head body having cooling channels.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within this disclosure.

### DETAILED DESCRIPTION OF EXEMPLARY EMBODIMENTS

The present disclosure is directed generally to a continuously cooled orbital weld head that can operate at much higher heat and at much higher amperage than previous welding solutions. Indeed, in some cases, the continuously cooled orbital weld head described herein may be capable of handling weld amperages that are two to four times higher than standard welding industry amperages. For instance, in some cases, the continuously cooled orbital weld head described herein may be implemented to weld copper tubing to copper joints at amperages between 125-200 amps, which would destroy conventional welding machines within the first few welds.

As noted above, conventional weld heads have been developed for industries welding materials such as stainless-steel alloys, titanium, Hastelloy, Inconel, or other metals. These metals are typically welded at amperages ranging from 40-120 amps. These metals, however, are insufficient for some emerging applications. For example, some welding applications use materials of construction that are of a higher melt temperature or are highly conductive. In such cases, the molten puddle required to form a sound weld cannot be produced unless significantly higher amperage is applied to the work surface (e.g., in the case of welding copper).

In welding applications where a higher amperage requirement is needed to maintain weld integrity, such amperages produce a significantly greater amount of heat, degrading the internal workings of the weld head, potentially causing severe damage to the weld head. These weld heads cannot perform the welds at these higher amperages on any kind of repeated basis. Indeed, these weld heads cannot withstand the heat from these higher amperages, as the mechanical properties of the materials they are constructed from break down and require costly repair. To sustain production rates for these new welding applications, different materials of construction are to be applied.

In some, more specific cases, the material of construction used by existing weld head designs centers around the mass of the weld heads, primarily the “body” or “housing” being made out of insulative materials aimed at protecting rotors, gears, electrical and control wiring, and the cooling system (e.g., hoses and chill block) from conductive heat and potential arc strike during operation. These insulative materials typically work very well when welding at amperages approximating 35-125 amps. Amperages in excess of this range will overheat current designs and degrade and/or damage these weld heads in a very short period of time (e.g., 1-5 welds).

In contrast to the conventional, insulative materials used in traditional weld heads, the embodiments herein construct the orbital weld head using the body as a large heat sink, with multiple fluid flow paths designed for high flow of coolant into the weld head body. Unlike traditional designs that utilize a small “chill block” inside the insulative body and fail to withstand repeated welds at high amperage (e.g., 125+ amps), the embodiments described herein have proven to withstand extreme heat. Highly conductive materials are implemented to manufacture the cooled weld head, offering super critical cooling of the weld head body. These materials may include aluminum, copper, and other conductive metals. These metals form the body of the weld head and provide cooling rates and performance that greatly exceeds traditional welding machines. The embodiments herein provide robust, durable weld heads that can perform repeated, high-amperage welds in high production, high output environments.

In some cases, weld head body construction may consist of various conductive materials and could be manufactured using metal 3D printing, investment casting, or intricate machining operations. This may allow for the flow of a fluid coolant to reach a large surface area and have that surface area be made up of a conductive material. This, in turn, may allow the conduction of heat produced from high amperage applications to be safely and effectively transferred to a cooling system, whereby a pump, heat exchanger, and/or cooling fans may be used to cool the return coolant before transfer back to the weld head. The thermally conductive weld head and cooling system may transfer heat at rates that existing, insulative weld heads were never designed to withstand due to (intentionally) poor conduction rate and heat transfer capacity.

The super critical cooled weld head embodiments herein may include at least some of the following: 1) a rotor designed with an insulative shield, 2) thermally conductive materials for the body of the orbital weld head. Conductive material applied as the body of the weld head conducts heat away from the inner workings of the weld head, allowing the weld head to operate at very high temperatures for extended periods of time. 3) Cooling channels providing higher surface areas inside the body of the weld head. As such, a cooling system can flow coolant at higher rates, allowing the body of the weld head to act as a massive heatsink instead of an insulator. 4) Tooling that allows a removable cassette to be clamped onto the body of the weld head and removed quickly using a cam-lock or other fastening mechanism.

Before describing the present disclosure in detail, it is to be understood that this disclosure is not limited to the specific parameters of the particularly exemplified systems, apparatus, assemblies, products, devices, kits, methods, and/or processes, which may, of course, vary. It is also to be understood that much, if not all of the terminology used herein is only for the purpose of describing particular embodiments of the present disclosure and is not necessarily intended to limit the scope of the disclosure in any particular manner. Thus, while the present disclosure will be described in detail with reference to specific configurations, embodiments, and/or implementations thereof, the descriptions are illustrative only and are not to be construed as limiting the scope of the claimed invention.

Various aspects of the present disclosure, including devices, systems, methods, etc., may be illustrated with reference to one or more exemplary embodiments or implementations. As used herein, the terms “exemplary embodiment” and/or “exemplary implementation” mean “serving as an example, instance, or illustration,” and should not necessarily be construed as preferred or advantageous over other embodiments or implementations disclosed herein. In addition, reference to an “implementation” of the present disclosure or invention includes a specific reference to one or more embodiments thereof, and vice versa, and is intended to provide illustrative examples without limiting the scope of the invention, which is indicated by the appended claims rather than by the following description.

Furthermore, unless defined otherwise, all technical and scientific terms used herein have the same meaning as commonly understood by one of ordinary skill in the art to which the present disclosure pertains. While a number of methods, materials, components, etc. similar or equivalent to those described herein can be used in the practice of the present disclosure, only certain exemplary methods, materials, components, etc. are described herein.

It will be noted that, as used in this specification and the appended claims, the singular forms “a,” “an” and “the” include plural referents unless the content clearly dictates otherwise. Thus, for example, reference to a “column” includes one, two, or more columns. Similarly, reference to a plurality of referents should be interpreted as comprising a single referent and/or a plurality of referents unless the content and/or context clearly dictate otherwise. Thus, reference to “columns” does not necessarily require a plurality of such columns. Instead, it will be appreciated that independent of conjugation; one or more columns are contemplated herein.

As used throughout this application the words “can” and “may” are used in a permissive sense (i.e., meaning having the potential to), rather than the mandatory sense (i.e., meaning must). Additionally, the terms “including,” “having,” “involving,” “containing,” “characterized by,” as well as variants thereof (e.g., “includes,” “has,” “involves,” “contains,” etc.), and similar terms as used herein, including the claims, shall be inclusive and/or open-ended, shall have the same meaning as the word “comprising” and variants thereof (e.g., “comprise” and “comprises”), and do not exclude additional, un-recited elements or method steps, illustratively.

Various aspects of the present disclosure can be illustrated by describing components that are coupled, attached, connected, and/or joined together. As used herein, the terms “coupled”, “attached”, “connected,” and/or “joined” are used to indicate either a direct association between two components or, where appropriate, an indirect association with one another through intervening or intermediate components. In contrast, when a component is referred to as being “directly coupled”, “directly attached”, “directly connected,” and/or “directly joined” to another component, no intervening elements are present or contemplated.

Thus, as used herein, the terms “connection,” “connected,” and the like do not necessarily imply direct contact between the two or more elements. In addition, components that are coupled, attached, connected, and/or joined together are not necessarily (reversibly or permanently) secured to one another. For instance, coupling, attaching, connecting, and/or joining can comprise placing, positioning, and/or disposing the components together or otherwise adjacent in some implementations.

As used herein, directional and/or arbitrary terms, such as “top,” “bottom,” “front,” “back,” “forward,” “rear,” “left,” “right,” “up,” “down,” “upper,” “lower,” “inner,” “outer,” “internal,” “external,” “interior,” “exterior,” “anterior,” “posterior,” “proximal,” “distal,” and the like can be used only for convenience and/or solely to indicate relative directions and/or orientations and may not otherwise be intended to limit the scope of the disclosure, including the specification, invention, and/or claims. Accordingly, such directional and/or arbitrary terms are not to be construed as necessarily requiring a specific order or position.

To facilitate understanding, like reference numerals have been used, where possible, to designate like elements common to the figures. Furthermore, alternative configurations of a particular element may each include separate letters appended to the element number. Accordingly, an appended letter can be used to designate an alternative design, structure, function, implementation, and/or embodiment of an element or feature without an appended letter. Similarly, multiple instances of an element and or sub-elements of a parent element may each include separate letters appended to the element number.

In each case, the element label may be used without an appended letter to generally refer to instances of the element or any one of the alternative elements. Element labels including an appended letter can be used to refer to a specific instance of the element or to distinguish or draw attention to multiple uses of the element. However, element labels including an appended letter are not meant to be limited to the specific and/or particular embodiment(s) in which they are illustrated. In other words, reference to a specific feature in relation to one embodiment should not be construed as being limited to applications only within said embodiment.

It will also be appreciated that where two or more values, or a range of values (e.g., less than, greater than, at least, and/or up to a certain value, and/or between two recited values) is disclosed or recited, any specific value or range of values falling within the disclosed values or range of values is likewise disclosed and contemplated herein. Thus, disclosure of an illustrative measurement or distance less than or equal to about 10 units or between 0 and 10 units includes, illustratively, a specific disclosure of: (i) a measurement of 9 units, 5 units, 1 units, or any other value between 0 and 10 units, including 0 units and/or 10 units; and/or (ii) a measurement between 9 units and 1 units, between 8 units and 2 units, between 6 units and 4 units, and/or any other range of values between 0 and 10 units.

Various modifications can be made to the illustrated embodiments without departing from the spirit and scope of the invention as defined by the claims. Thus, while various aspects and embodiments have been disclosed herein, other aspects and embodiments are contemplated. It is also noted that systems, apparatus, assemblies, products, devices, kits, methods, and/or processes, according to certain embodiments of the present disclosure may include, incorporate, or otherwise comprise properties, features, components, members, and/or elements described in other embodiments disclosed and/or described herein. Thus, reference to a specific feature in relation to one embodiment should not be construed as being limited to applications only within said embodiment. The headings used herein are for organizational purposes only and are not meant to be used to limit the scope of the description or the claims.

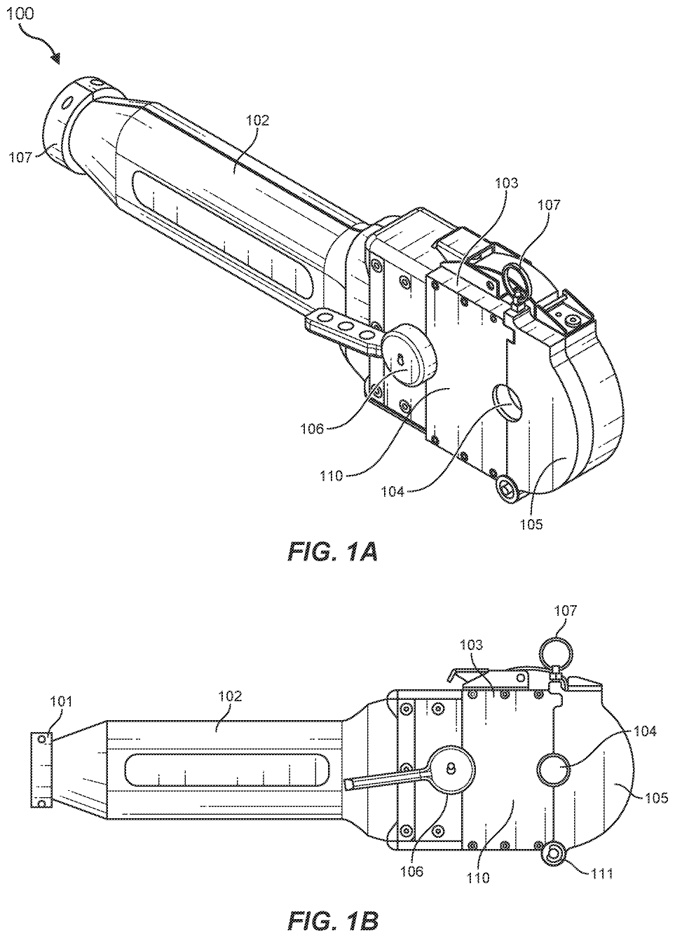

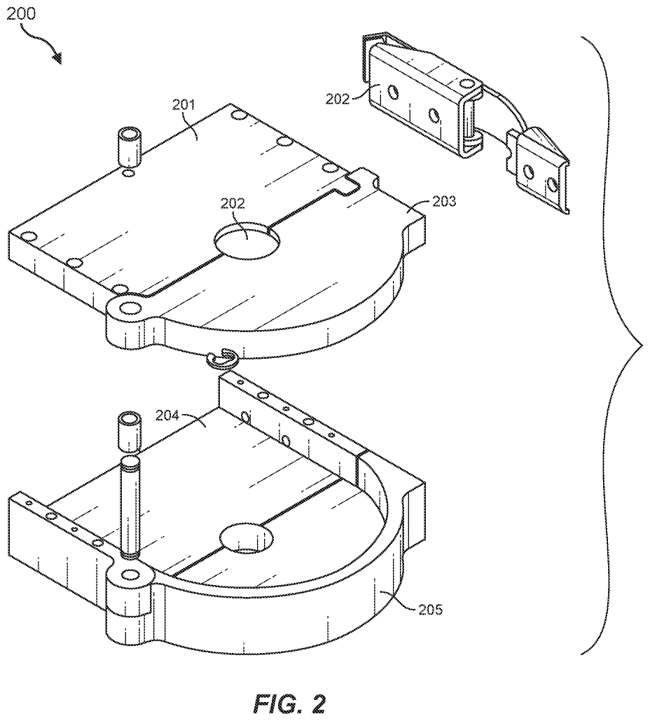

Turning now to the Figures, FIG. 1A illustrates an embodiment of a system 100. The system 100 may include more or fewer components than those shown in FIGS. 1A and 1B. For instance, the system 100 may include electrical lines, pressurized fluid lines, inert gas lines, or other input lines that help power or mechanically operate the system. In some cases, the system 100 may be an orbital welding system or machine and, specifically, a high amperage, continuously cooled orbital welding machine. In contrast to conventional orbital welding machines or systems that implement insulative weld head bodies and operate at amperages below 125 amps, the embodiments herein implement a conductive weld head body that is continuously cooled using a pressurized, fluid coolant. This allows the system 100 to operate at amperages above 125 amps and, as a result, to weld materials that were previously not able to be welded at all or were not able to be welded with any level of consistency or quality (e.g., copper tubing and copper fittings).

The system 100 of FIG. 1A includes a fitting 101 that attaches to and surrounds various input lines, including power input lines, fluid input lines, gas input lines (e.g., for inert gases), or other input lines. The system 100 also includes a support structure 102, some of which may function as a handle. The handle, which may be part of the support structure 102, is used to hold and control the orbital welding system when operated about a welding piece. The support structure 102 may also include other subframes or supporting members that provide structural support and rigidity to the orbital welding system. The support structure 102 may provide installation mounts, screw holes, clips, or other fastening mechanisms or securing mechanisms to provide support for the various electrical, mechanical, and fluidic elements, or other orbital welding components of the orbital welding system.

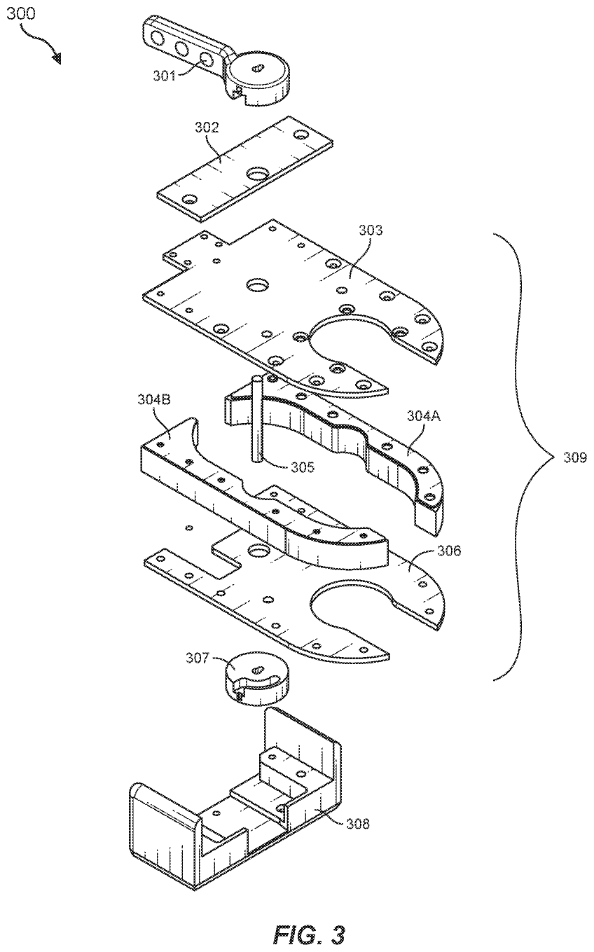

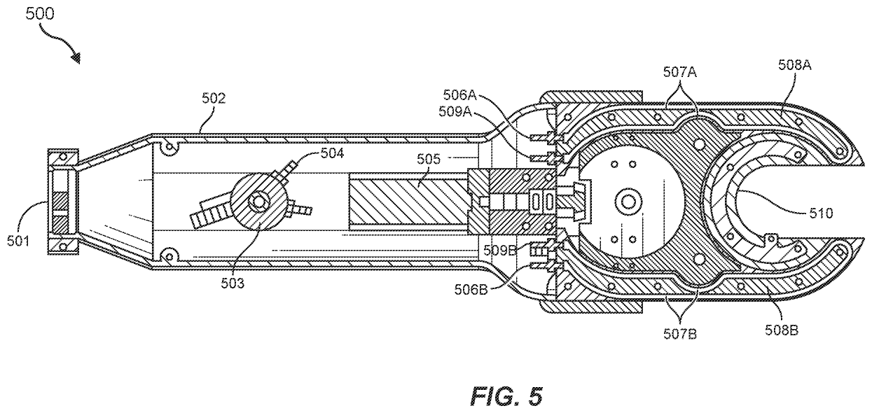

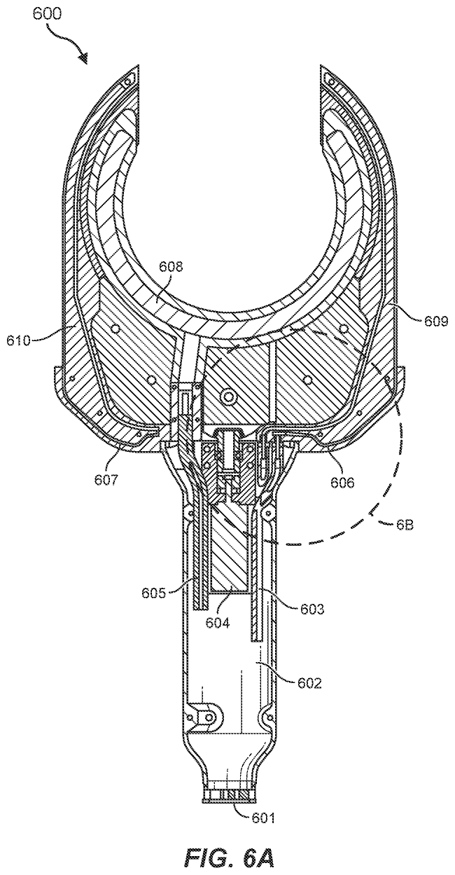

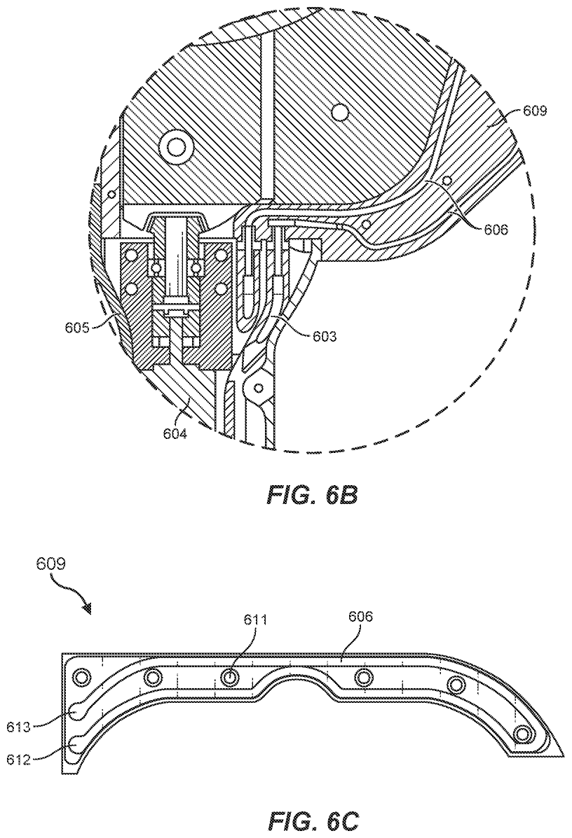

Still further, the system 100 includes an orbital weld head body 103 attached to the support structure 102. The orbital weld head body 103 may be wholly or at least partially made from a thermally conductive material (e.g., copper, gold, silver, etc.). The orbital weld head body may include at least one cooling bar (e.g., 304A of FIG. 3) that spans at least a portion of the length of the orbital weld head body 103. The cooling bar may include one or more internal cooling channels (e.g., 507A/507B of FIG. 5) to route coolant through the cooling bar of the orbital weld head body 103. The orbital weld head body 103 may also include at least one pressurized fluid input line (e.g., 603 of FIG. 6) that attaches to the internal cooling channels of the cooling bar and conducts a fluid coolant to the internal cooling channels of the cooling bar. While many of these individual components are not shown in FIG. 1A, these components are shown in greater detail with regard to FIGS. 3-6C.

As shown in FIGS. 1A and 1B, the orbital weld head body 103 may be part of a removable cassette 110. The removable cassette 110 may be removed from the support structure 102 via a locking handle 106 and/or locking pin. In some cases, portions of the removable cassette itself may be hingedly connected (e.g., via hinge 111) and may detach from the main body of the cassette via a locking pin 107. This detaching may allow the hinged portion 105 to swing downward and allow a piece of tubing and/or a joint to be inserted into the aperture 104 for orbital welding. Once the welding pieces have been inserted, the hinged portion 105 may be closed and locked in place via the locking pin 107. The internal weld head may then rotate around the welding pieces to weld the pieces together. The removable cassette 110 is shown and described in greater detail below with regard to FIG. 2.

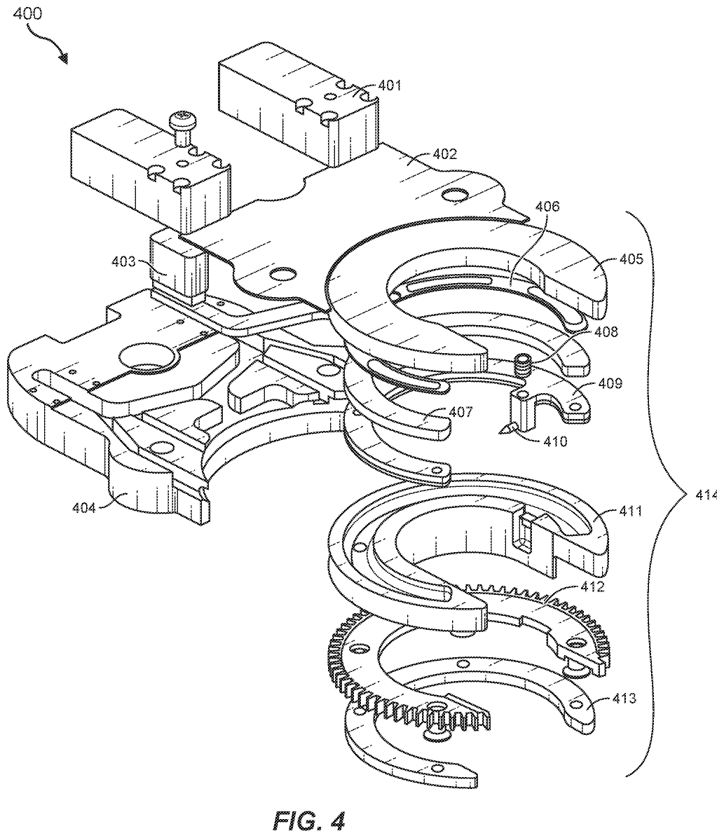

FIG. 2 illustrates an embodiment of a removable cassette 200 having multiple components. For instance, the removable cassette 200 may have an upper portion 201 and a lower portion 204. The weld head and cooling bars (generally shown in FIGS. 3 and 4) may be positioned within the upper and lower portions of the removable cassette 200. The removable cassette 200 includes an aperture 202 that allows for a portion of tubing and/or a fitting. In some cases, the removable cassette 200 may have one or more cooling bars, each with their own cooling channels. These cooling bars and channels may be in addition to any other cooling bars (e.g., in the weld head body). The cooling bars and channels in the removable cassette 200 may have their own pressurized fluid input lines to supply fluid coolant to the cassette's cooling bars. In such cases, the exterior portion of the removable cassette 200 may enclose and protect the cooling bars and cooling channels. The upper and lower portions of the removable cassette 200 may be fastened together and held securely in place via a clip 202 or other fastening mechanism.

In some cases, unclasping the clip allows a hinged, detachable portion 203/205 of the removable cassette 200 to open and allow greater access to the aperture 202. For example, when in an open position, a fitting and a tubing section may be placed within the aperture 202. The fitting and tubing sections may be made of copper, aluminum, stainless steel, or substantially any other weldable, non-ferrous material. The hinged, detachable portion 203/205 may then swing shut, enclosing the fitting and tubing sections. In some cases, the hinged, detachable portions 203 and 205 may each open separately and may each have a separate clip that secures the respective detachable portions to the upper and lower portions. The weld head and weld head body are contained within cavity created by the upper portion 201 and the lower portion 204 of the removable cassette 200. The weld head and weld head body are described in greater detail below with regard to FIG. 3.

FIG. 3 illustrates an embodiment 300 of an expanded view of a weld head body, a weld head, and associated components. As noted above, the weld head and weld head body may reside in a cavity created by the removable cassette 200 of FIG. 2. The removable cassette 200 may, itself, fit on an end portion of an orbital welding system. The embodiment 300 includes a cooling bar 304A that spans at least a portion of the length of the orbital weld head body 309. The cooling bar 304A includes various internal cooling channels (not visible in FIG. 3) to route coolant through the cooling bar of the orbital weld head body 309. In some cases, the weld head body includes a second, different cooling bar 304B that spans an opposite portion of the length of the orbital weld head body 309.

The cooling bars 304A and 304B may be covered and held in place via protective plates 303 and 306 that attach to upper and lower portions of the cooling bars. The cooling bars and protective plates 303/306 may, themselves, be held in place via a rotatable fastening mechanism 301 that connects to a latching mechanism 307 via a rod 305 that extends through the weld head body 309 between structural elements 302 and 308. As noted above, the cooling bars may be made of a conductive material. In some cases, the protective plates 303 and/or 306 may be made of a conductive material. In contrast to traditional systems in which weld head bodies are insulated, the weld head body of FIG. 3 may be designed to conduct heat. This conducted heat is then dissipated through cooling channels in the cooling bars 304A/304B. This active, liquid cooling allows the weld head (not shown in FIG. 3) to operate at a very high temperatures that result from abnormally high amperages. Indeed, the embodiments herein may operate repeatedly and reliably at 2×-4× the traditional amount of amperage used in orbital welding (e.g., 125-200 amps, or more).

The cooling bars 304A/304B may surround an internal weld head component and weld head, as generally shown in FIG. 4. FIG. 4 illustrates an embodiment 400 of an expanded view of a weld head 414 and accompanying components. The weld head 414 may include multiple component pieces including an outer protective layer 405, an insulative layer 406, conductive layers 407 and 409 separated by a spacer 408, a second insulative layer 411, a gearing layer 412 that rotates the weld head about an axis, and an outer protective layer 413. The weld head 414 may include an arc 410 made of tungsten or other material. The weld head 414 may be connected to structural support components 401, 402, 403, and 404. These structural support components may hold the weld head 414 in place within the weld head body (e.g., in the cavity between the cooling bars 304A and 304B. These structural components may route electricity to the conductive layers 407 and 409 of the weld head 414 and may also route rotational force (provided by a motor) to the gearing layer 412 to rotate the teeth of the gearing layer.

The insulative layers 406 and 411 may allow the weld head 414 to withstand and repeatedly operate using very high amperages without melting or exploding. The insulative layer may be made of ceramic or other thermally dielectric insulating material, while the conductive layers may be made of copper or another conductor. The weld head 414 may operate for long and sustained time periods while receiving unusually high amounts of current (e.g., 125+ amps). Because the weld head body is thermally conductive and actively cooled, and because the weld head 414 includes insulative layers that prevent arcing to structural components or other layers of the weld head, the embodiments herein may repeatedly and reliably weld at current levels that are not possible on traditional orbital welding machines.

FIG. 5 illustrates a top view of an embodiment of an orbital welding machine or system 500. In this embodiment, the top protective plating has been removed to allow visibility of the underlying components 505. The orbital welding system 500 includes an input port 501 through which power, pressurized fluid, electrical grounding, or other electrical or mechanical inputs may be provided to the orbital welding system 500. The orbital welding system 500 may further include a support structure 502, at least a part of which may act as a handle for a user during the orbital welding process.

Still further, at least in some embodiments, the orbital welding system 500 includes a fluid diverter 503. The fluid diverter 503 may include a single input and two or more fluid outputs 504. In some cases, hoses may run from the input port 501 to the diverter 503 and from the fluid outputs 504 to the internal cooling channels 507A and 507B of the cooling bars 508A and 508B. The internal cooling channels 507A/507B may each include input ports 506A/506B and output ports 509A/509B. In such cases, the cool fluid may flow into the input ports 506A/506B, circulate around the respective cooling channels 507A/507B, and reach the output ports 509A/509B. The fluid, which has been heated up while traveling through the internal cooling channels 507A/507B can then exit the orbital welding system 500 and be cooled by an external heat pump or other cooling mechanism.

The weld head 510, as noted above, may operate at very high amperages. These high amperages cause a large amount of heat. In contrast to traditional systems that implement insulated weld head bodies, the embodiments herein implement thermally conductive weld head bodies and, specifically, cooling bars 508A/508B that are part of the weld head bodies. The thermally conductive cooling bars 508A/508B, just by being thermally conductive, will transfer at least some of the heat away from the orbital weld head 510 and any welding pieces. Additionally, the cooling bars 508A/508B also include internal cooling channels 507A/507B that route pressurized coolant through the cooling bars. This pressurized coolant continuously pumps the heated coolant out of the system and continually pumps new, cooler fluid into the internal cooling channels 507A/507B of the cooling bars. This process greatly reduces the heat of the weld head body and its internal components, allowing the weld head 510 to make repeated, accurate, and sound orbital welds hour after hour.

FIGS. 6A-6C illustrate an embodiment of an orbital welding system 600 in greater detail. In FIG. 6A, for example, the internal cooling channels 606 and 607 may be seen to extend up a one side of each cooling bar 609 and 610 and follow down an opposite side of each cooling bar. The cooling bars 609/610 may at least partially surround the orbital weld head 608. As noted above, the orbital weld head body, including the cooling bars 609/610 and orbital weld head 608, may be secured to the support structure 602 using multiple different fastening mechanisms (e.g., screws, clips, or other fasteners). In the embodiment of FIG. 6A, electrical power is fed to the orbital weld head 608 via a power input line 605. Similarly, a pressurized cooling fluid may be fed or pumped to the internal cooling channels 606 and 607 of the respective cooling bars via a fluid input line 603. Other inputs, such as inert gas, may also be provided through the input port 601.

In some cases, a fluid input line may reach a diverter where the fluid is diverted into each of the two cooling bars 609 and 610. It should be noted that, while many of the embodiments herein implement two cooling bars, substantially any number of cooling bars may be used. Indeed, in some embodiments, a single cooling bar may be used, while in other cases, multiple cooling bars may be stacked on top of each other or placed in different positions around the orbital weld head 608. Moreover, while the cooling bars 609/610 are generally shown as being “C-shaped” curves, the cooling bars 609/610 may be formed in substantially any shape, including circular, square, triangular, rectangular, “horseshoe-shaped,” irregularly shaped, or formed in some other shape. The internal cooling channels 606 and 607 may be correspondingly shaped in such cases, following the contours of the cooling bars 609/610.

Still further, substantially any number of internal cooling channels may be used. In some cases, for instance, a cooling bar may be a height of three units (e.g., mm, cm, etc.), with a cooling channel being placed at one unit and a second cooling channel being placed at two units. Or, a cooling bar may be five units thick, and may have cooling channels placed at one unit, two units, three units, and four units. Thus, in such cases, multiple cooling channels may be placed on top of each other, separated by some distance. In these embodiments, each internal cooling channel may have its own pressurized fluid input and output line, or some or all channels may share fluid input and output lines. Thus, it will be recognized that many variations in size, shape, number, and placement of cooling bars and internal cooling channels may be implemented within an orbital welding machine or system.

FIG. 6A includes a dotted-line circle 6B, the contents of which are illustrated in greater detail in FIG. 6B. FIG. 6B illustrates a power input line 605 and a fluid input line 603. The power input line 605 may provide power to the orbital weld head, while the fluid input line 603 may provide coolant to the internal cooling channel 606. The internal cooling channel 606 may have an input line and a return line that traverses some or all of the length of the cooling bar 609. Other input lines, including an inert gas input line 604 may also be implemented within the orbital welding system.

FIG. 6C illustrates a single cooling bar 609 with an input port 612, and output port 613, and a cooling channel 606. The cooling channel may run along the outside edge of the cooling bar 609 and may conform to the shape and size of the cooling bar. In some cases, the cooling bar 609 may include apertures 611 for connecting to other components including protective plates that may cover the cooling bars. In such cases, the cooling channel 606 may run around or between the apertures. In some cases, the widths of the cooling channel 606 may be uniform or may vary over the span of the cooling bar. Thicker widths may allow for more coolant, while thinner widths may allow for more maneuverability or flexibility when designing the flow of the internal cooling channel 606.

In some cases, the thermal conductivity of the orbital weld head body may be specifically designed or manufactured to have or exceed at least a minimum thermal conductivity threshold value. Such an orbital weld head body may be designed to orbitally weld copper pieces, for example, using at least 100 amps, without ruining the orbital weld head. The orbital weld head, which, as shown in FIG. 6A, is positioned between the two cooling bars 609 and 610, may be insulated so that it, too, can withstand unusually high amounts of electrical current. Using a thermally conductive weld head body, in combination with cooling bars with internal cooling channels and an insulated orbital weld head, allows the embodiments herein to perform orbital welds and to weld materials that were not either not possible using previous equipment, or would result in melted and unusable weld heads and/or melted weld head bodies.

In addition to the system described above, an orbital welding machine may be provided that includes a support structure configured to provide support for one or more orbital welding components and an orbital weld head body attached to the support structure. The orbital weld head body includes a thermally conductive material. The orbital weld head body includes: at least one cooling bar that spans at least a portion of the length of the orbital weld head body, the cooling bar including one or more internal cooling channels to route coolant through the cooling bar of the orbital weld head body, and at least one pressurized fluid input line that attaches to the internal cooling channels of the cooling bar and conducts a fluid coolant to the internal cooling channels of the cooling bar.

Additionally or alternatively, an apparatus may be provided that includes a support structure configured to provide support for one or more orbital welding components and an orbital weld head body attached to the support structure. The orbital weld head body includes a thermally conductive material. The orbital weld head body includes: at least one cooling bar that spans at least a portion of the length of the orbital weld head body, the cooling bar including one or more internal cooling channels to route coolant through the cooling bar of the orbital weld head body, and at least one pressurized fluid input line that attaches to the internal cooling channels of the cooling bar and conducts a fluid coolant to the internal cooling channels of the cooling bar.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

We claim:

1. A system comprising:
a support structure configured to provide support for one or more orbital welding components; and
an orbital weld head body attached to the support structure, the orbital weld head body comprising a thermally conductive material, the orbital weld head body including:
at least one cooling bar that spans at least a portion of the length of the orbital weld head body, the cooling bar including one or more internal cooling channels to route coolant through the cooling bar of the orbital weld head body; and
at least one pressurized fluid input line that attaches to the internal cooling channels of the cooling bar and conducts a fluid coolant to the internal cooling channels of the cooling bar.

2. The system of claim 1, wherein the internal cooling channel extends up a first side of the cooling bar and follows down an opposite, second side of the cooling bar.

3. The system of claim 1, further comprising a removable cassette that is detachably connected to the support structure.

4. The system of claim 3, wherein the removable cassette includes an orbital weld head configured to orbitally weld two or more pieces of material together.

5. The system of claim 4, wherein the two or more pieces of material that are to be orbitally welded together are formed from copper.

6. The system of claim 1, wherein the orbital weld head body further includes:
a second cooling bar that spans at least a portion of the length of the orbital weld head body, the second cooling bar including one or more internal cooling channels to route coolant through the second cooling bar of the orbital weld head body; and
a second pressurized fluid input line that attaches to the internal cooling channels of the second cooling bar and conducts a fluid coolant to the internal cooling channels of the second cooling bar.

7. The system of claim 6, further comprising a fluid diverter connected to the pressurized fluid input line and the second pressurized fluid input line, wherein the fluid diverter provides the fluid coolant to both the internal cooling channels of the cooling bar and the internal cooling channels of the second cooling bar.

8. The system of claim 6, wherein the cooling bar and the second cooling bar are secured to the support structure with a plurality of different fastening mechanisms.

9. The system of claim 6, wherein an orbital weld head is positioned between the cooling bar and the second cooling bar.

10. The system of claim 9, wherein the orbital weld head, the cooling bar, and the second cooling bar are covered by structural plates.

11. The system of claim 9, wherein the orbital weld head includes at least one insulative layer formed from a thermally insulating material.

12. The system of claim 1, wherein the thermal conductivity of the orbital weld head body exceeds a minimum thermal conductivity threshold value.

13. An orbital welding machine comprising:
a support structure configured to provide support for one or more orbital welding components; and
an orbital weld head body attached to the support structure, the orbital weld head body comprising a thermally conductive material, the orbital weld head body including:
at least one cooling bar that spans at least a portion of the length of the orbital weld head body, the cooling bar including one or more internal cooling channels to route coolant through the cooling bar of the orbital weld head body; and
at least one pressurized fluid input line that attaches to the internal cooling channels of the cooling bar and conducts a fluid coolant to the internal cooling channels of the cooling bar.

14. The orbital welding machine of claim 13, wherein the orbital weld head body further includes:
a second cooling bar that spans at least a portion of the length of the orbital weld head body, the second cooling bar including one or more internal cooling channels to route coolant through the second cooling bar of the orbital weld head body; and
a second pressurized fluid input line that attaches to the internal cooling channels of the second cooling bar and conducts a fluid coolant to the internal cooling channels of the second cooling bar.

15. The orbital welding machine of claim 14, further comprising an orbital weld head that is positioned between the cooling bar and the second cooling bar.

16. The orbital welding machine of claim 15, wherein the orbital weld head is configured to orbitally weld copper using at least 100 amps.

17. The orbital welding machine of claim 14, wherein the cooling bar and the second cooling bar are both part of a removable cassette that is detachably attached to the support structure.

18. The orbital welding machine of claim 14, wherein the orbital weld head, the cooling bar, and the second cooling bar are covered by structural plates.

19. The orbital welding machine of claim 14, wherein the orbital weld head includes at least one insulative layer formed from a thermally dielectric insulating material.

20. An apparatus comprising:
a support structure configured to provide support for one or more orbital welding components; and
an orbital weld head body attached to the support structure, the orbital weld head body comprising a thermally conductive material, the orbital weld head body including:
at least one cooling bar that spans at least a portion of the length of the orbital weld head body, the cooling bar including one or more internal cooling channels to route coolant through the cooling bar of the orbital weld head body; and
at least one pressurized fluid input line that attaches to the internal cooling channels of the cooling bar and conducts a fluid coolant to the internal cooling channels of the cooling bar.
